(19) United States
(12) Patent Application Publication
(10) Pub. No.: US 2009/0158546 A1
(43) Pub. Date: Jun. 25, 2009

(54) WINDSHIELD WIPER SYSTEM

(75) Inventor: Achim Hawighorst, Buehlertal (DE)

Correspondence Address: MICHAEL BEST & FRIEDRICH LLP, 100 EAST WISCONSIN AVENUE, MILWAUKEE, WI, 53202, US

(73) Assignee: ROBERT BOSCH GMBH, Stuttgart (DE)

(21) Appl. No.: 12/305,259

(22) PCT Filed: Jul. 12, 2007
(86) PCT No.: PCT/EP2007/057153

§ 371 Date: Dec. 17, 2008

(30) Foreign Application Priority Data
Aug. 31, 2006 (DE) 10 2006 040 735.0

(51) Int. Cl. B60S 1/08

(52) U.S. Cl. 15/250.31

(57) ABSTRACT

The invention relates to a windshield wiper system for motor vehicles, comprising at least one assembly (4) containing a wiper motor and at least three securing elements (5, 5′, 10) that are secured to three securing points, arranged in a triangle. At least one securing element comprises a U-shaped lug (10) that is inserted or hung into a bracket-type seat (11) on a supporting structure.

### BACKGROUND AND SUMMARY OF THE INVENTION

The invention relates to a windshield wiper system for vehicles, in particular motor vehicles with a body.

Wiper systems have to meet requirements which are firstly determined in accordance with functional operating parameters. These include the size and geometry of the surface to be cleaned, wind loads to be anticipated, the required wiper frequency and associated mechanical parameters, i.e. forces and moments. In order to be able to reliably absorb said forces and moments, it is customary to connect wiper systems to a corresponding supporting structure at a plurality of securing points. In order to prevent operating noises from being coupled into the interior of the vehicle, said securing points are generally provided with damping elements. The operation of vehicles also makes it necessary for the means of securing all of the add-on parts to have a certain shock resistance in order to reliably prevent detachment while underway and in the event of brief disturbing accelerations occurring. For this purpose, it is advantageous for the securing concept to include securing points in the vicinity of the heaviest assemblies of a wiper system. Against the background of modern mass production, all of these requirements have to be associated as far as possible with easy installability of the wiper system.

It is known to support wiper systems at at least three securing points which together form a triangle, with one securing point being arranged in the direct vicinity of the wiper motor (DE 198 33 404 A1, DE 101 55 269 A1). The securing elements used include, for example, plug-in pins which are introduced into corresponding openings in the body. The required retaining action is partially obtained by means of frictional and interlocking actions of damping elements at the securing points, as a result of which a fixed, defined pushing-in of the plug-in pins forms a form of rapid installation which, under some circumstances, does not require any further measures for securing the wiper system. However, plug-in pins require a sufficient amount of construction space in front of and behind the supporting structure in order, prior to the installation, to be able to be arranged as far as possible without tilting in front of the opening provided for the securing and, during the installation, to be able to be inserted into the opening to a sufficient depth. Furthermore, securing systems having a plurality of plug-in pins are relatively exacting in terms of manufacturing tolerances which must be observed, in particular when the receiving openings are arranged on different components. This may be associated with an undesirable outlay on finishing work particularly when different manufacturing technologies are brought together by different supplier systems.

Numerous other known securing systems for wiper systems partially comprise complex or multi-part securing elements, the high installation outlay of which constitutes a considerable disadvantage.

The problem of the invention is to provide a wiper system which is distinguished by simple installability and high operational reliability, permits the use of securing points at which little construction space is available and which is relatively inexacting in terms of observing manufacturing tolerances.

The invention comprises a windshield wiper system for vehicles, comprising at least one wiper motor and at least three securing elements which are secured to securing points arranged in a triangle, wherein at least one securing element comprises a U-shaped lug which is inserted or hung into a bracket-type seat on a supporting structure, preferably the body.

Further securing elements advantageously include corresponding pairs of securing elements which are brought into engagement with one another in a direction deviating from the direction of insertion of the U-shaped lug into the bracket-type seat, and are secured to one another. These may be, for example, plug-in pins which are introduced into corresponding openings in a direction deviating from the direction of insertion of the U-shaped lug into the bracket-type seat, and are fixed in said openings.

In order to obtain the retaining action on the non lug-shaped securing elements, damping elements which act in a frictional and interlocking manner can advantageously be provided on the respective securing points.

If conventional securing elements are used, the good efficacy and reliability thereof remain usable in a windshield wiper system according to the invention. However, the combination according to the invention with at least one pair comprising a U-shaped lug and a bracket-type seat considerably simplifies the installation of the windshield wiper system, in particular in the event of use of securing points requiring little construction space because of their structure.

It is advantageous if at least one U-shaped lug is connected fixedly to the gear housing or gear cover of the wiper motor. This results in a securing point which is located in the vicinity of the heaviest assembly of the windshield wiper system, as a result of which the latter is effectively prevented from swinging up. Furthermore, with solutions of this type, confined securing locations are made accessible, the construction space of which only has to be sufficient for receiving the assembly comprising wiper motor and gear, since the necessity of installation-induced lifting or pivoting movements is dispensed with, if appropriate, or the deflection of such movements is at least significantly reduced in comparison to the prior art.

Depending on the type of construction and shape of the housing, in particular in the case of gear-free wiper systems, for example in the case of wiper direct drives, it may be advantageous for the abovementioned reasons if at least one U-shaped lug is arranged on the outer side of the wiper motor.

A further advantage arises if the bracket-type seat on the supporting structure is a sheet-metal bracket which projects out of the body plane. This embodiment can be brought about with little technological outlay by simple spot welding if a closed bracket and body surface is required. As an alternative, a sheet-metal bracket which projects out of the body plane can be produced by a simple punching and bending step on the body sheet, which helps to reduce manufacturing costs.

### BRIEF DESCRIPTION OF THE DRAWINGS

Further advantages, features and details of the invention emerge from the description below in which preferred exemplary embodiments of the invention are described in detail with reference to the drawings, in which:

FIG. 1 shows a schematic illustration of part of a windshield wiper system according to the invention with a wiper linkage;

FIG. 2 shows a schematic illustration of part of a windshield wiper system according to the invention with a wiper direct drive;

FIG. 3 shows a schematic sectional illustration of a U-shaped lug which, according to the invention, is hung into a bracket-type seat;

FIG. 4 shows a schematic sectional illustration of a U-shaped lug which, according to the invention, is inserted into a bracket-type seat.

### DETAILED DESCRIPTION

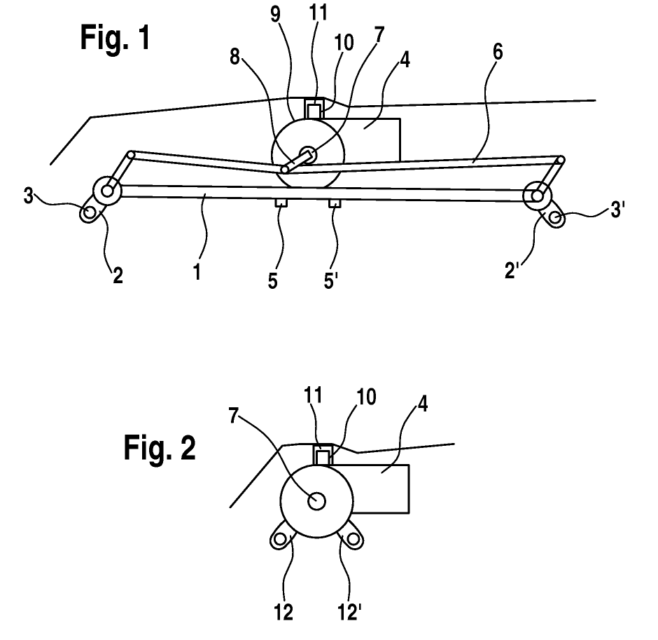

FIG. 1 shows a schematic illustration of part of a windshield wiper system according to the invention with a wiper linkage. The latter comprises a support 1 which is connected at its ends to formed parts 2, 2′ for connection to the body of a vehicle. For this purpose, the formed parts 2, 2′ have conventional securing elements. In the present case, the latter comprise plug-in pins 3, 3′ which engage in corresponding openings in the body and are held there by damping elements acting in a frictional and interlocking manner. An assembly 4 composed of a wiper motor and gear is connected to the support 1 via further securing elements 5, 5′. Within the context of the invention, the description of the assembly 4 composed of the wiper motor and gear applies below also to gear-free wiper motors or to arrangements with gear and motor components which are not clearly separable, when they are used in wiper systems. The support 1 with the formed parts 2, 2′ and the assembly 4 composed of wiper motor and gear statically form a unit, as a result of which securing points in the vicinity of the motor and securing points in the vicinity of the support can contribute equally to the stable securing of the entire arrangement. Furthermore, the wiper linkage 6 which is actuated via a crank 8 driven by an output shaft 7 is supported on the support 1. A U-shaped lug 10 which is provided for securing in a bracket-type seat is located directly on the housing 9 of the gear. In this manner, securing points which are at a distance from each other are available in order to be able to reliably absorb forces and moments which occur.

The U-shaped lug 10 is designed with a rectangular opening, as a result of which it comprises a rectilinear transverse web 11 on its upper side. Given a certain width for the bracket-type seat, the length of said transverse web 11 makes it possible to predetermine a remaining amount of transverse play which makes it significantly easier to install the windshield wiper system, i.e. connect the remaining securing elements, when the web 11 of the U-shaped lug 10 is already located in the bracket-type seat. If all of the securing elements are secured, said lateral play is no longer actively required. However, it brings about greater tolerance, in comparison to conventional wiper systems, in relation to manufacturing tolerances because only the securing elements which are located on the formed parts of the support 1 require precisely corresponding positions of securing elements on the body. However, said securing elements are generally located in virtually one plane on a component, and therefore it is possible to provide it with small manufacturing tolerances without a great outlay.

FIG. 2 shows a schematic illustration of part of a windshield wiper system according to the invention with a wiper direct drive. The system illustrated does not have a separate support, but rather has formed parts 12, 12′ which are secured directly to the assembly 4, which is composed of the wiper motor and gear, and are available for the securing to a vehicle body via conventional securing elements. In spite of the reduced base length between the individual securing points, sufficient durability of the securing of the windshield wiper system can be achieved by means of a star-shaped arrangement of the two formed parts 12, 12′ and of a U-shaped lug 10 according to the invention which is provided for securing in a bracket-type seat. The U-shaped lug 10 is in turn of rectangular design, as a result of which the above-described advantages of a controlled lateral play can be used in the same manner and greater insensitivity to manufacturing tolerances is achieved.

Depending on the technological requirements, the U-shaped lug 10 according to the invention can be formed integrally from the material of the gear cover or housing or can be connected thereto as an attachment. The design as an attachment permits a more flexible configuration, since even locations which, for technological reasons, are not suitable for an integral shaping from a basic body, can be used for the attachment of the U-shaped lug 10. This applies in particular to positions directly on the housing of the wiper motor.

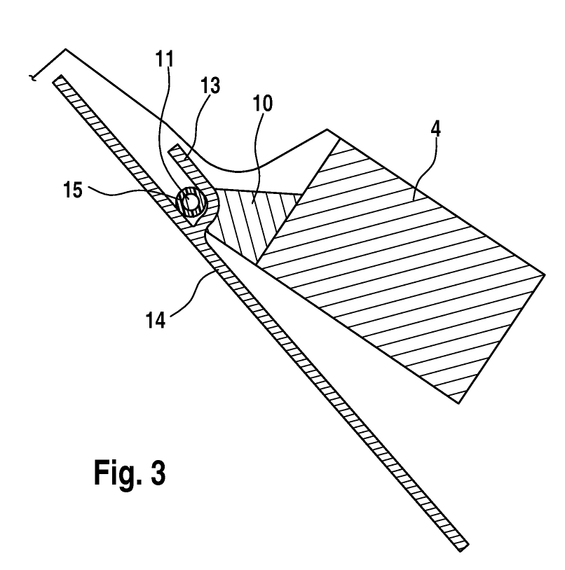

FIG. 3 shows a schematic sectional illustration of a U-shaped lug 10 which, according to the invention, is hung into a bracket-type seat 13. The illustration schematically comprises the assembly 4 which is composed of wiper motor and gear and on which there is a rectangular, U-shaped lug 10, the upper rectilinear transverse web 11 of which has a round cross section. The round cross section has the advantage that tilting movements which have possibly to be undertaken during the hanging-in operation or during the alignment of the windshield wiper system are not obstructed by the geometry of the transverse web.

According to the invention, a sheet-metal bracket 13 which projects out of the body plane serves as a seat into which the transverse web 11 of the U-shaped lug 10 is hung. The sheet-metal bracket 13 is composed of a body sheet and has been worked out of the plane of the body 14 in a punching and bending step.

The sheet-metal bracket 13 acts in a load-absorbing manner at least during the installation of the windshield wiper system. At the same time, in addition to the lateral play already described, such a construction affords the possibility of also displacing the transverse web 11 of the lug 10 parallel to the body 14 in the hanging-in direction and of defining a corresponding position by securing the rest of the securing elements. In this case, the rest of the securing elements largely take on the function of load-absorbing supports while the sheet-metal bracket 13 merely secures the arrangement against tipping.

An elastic damping element 15 is arranged between the transverse web 11 of the U-shaped lug 10 and the bracket-type seat 13. Said damping element 15 prevents operating noises from being coupled into the interior of the vehicle. At the same time, given a correspondingly taut design, it acts as a securing aid during the installation of the windshield wiper system, since it prevents the arrangement from too easily slipping before the remaining securing elements are secured.

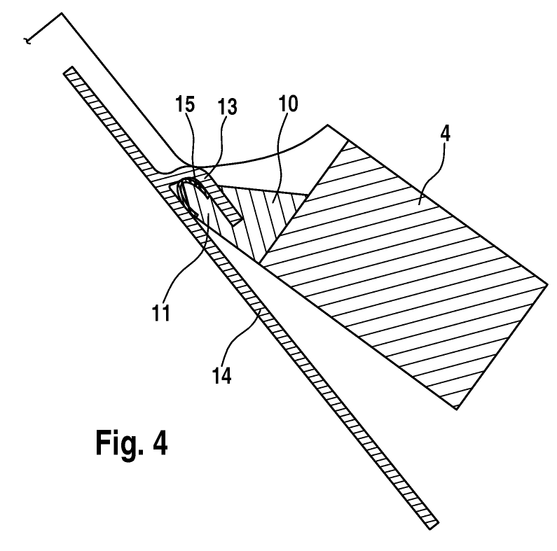

FIG. 4 shows a schematic sectional illustration of a U-shaped lug which, according to the invention, is inserted into a bracket-type seat. In this configuration, the opening of the sheet-metal bracket 13, which projects out of the body plane and, in the present case, serves as the seat according to the invention, points in the direction of the assembly 4 composed of wiper motor and gear. As a result, the insertion can take place without any lifting movement, and therefore this variant is particularly suitable and preferable for securing points at confined fitting locations to which access is difficult.

In analogy to the variant of securing the U-shaped lug by hanging it in, the load-absorbing function of the bracket-type seat 13 is dispensed with from the outset. However, after the remaining securing elements are secured, the U-shaped lug 10 is likewise prevented from slipping out. In the fully installed state of the windshield wiper system, the function of the bracket-type seat 13 is again limited to securing the entire arrangement against tilting. In this embodiment too, the possibility of the transverse web 11 of the U-shaped lug 10 being displaced provides a degree of freedom during the installation of the windshield wiper system, said degree of freedom considerably reducing a dependency on manufacturing tolerances.

Since no lifting movement whatsoever has to be carried out, at least at the location of the connection, in order to insert the U-shaped lug 10 into the bracket-type seat 13, particularly shallow fitting locations can be made accessible for the placing of such a securing according to the invention. There merely has to be sufficient space available for the formation of the bracket-type seat 13. In the present exemplary embodiment, the upper rectilinear transverse web 11 of the U-shaped lug 10 has a shallow cross section in the form of an ellipse. With cross sections of this type, the construction space required for the formation of the bracket-type seat 13 can be reduced even further without having to accept reduction in the strength of the U-shaped lug 10.

An elastic damping element 15 is again arranged between the transverse web 11 of the U-shaped lug 10 and the bracket-type seat 13. Given a corresponding orientation of the main direction of extent in the cross-sectional plane, the shallow cross section of the transverse web 11 of the U-shaped lug 10 affords a further structural advantage. The latter can be used in particular whenever structural boundary conditions in the fitting surroundings of the windshield wiper system require the system to be inserted in a certain orientation. In this case, the cross section of the upper transverse web 11 has to be defined in such a manner that it has its minimal extent perpendicular to the direction of insertion during the insertion of the U-shaped lug 10 into the bracket-type seat 13. This firstly makes the insertion easier. If, in order to secure the rest of the securing elements, the entire arrangement is pivoted into the final position, the associated rotation of the upper transverse web 11 results in an expansion of the transverse web 11 with an elongate cross section, as a result of which the damping element 15 is prestressed and the U-shaped lug 10 in turn is secured at least temporarily and is secured against slipping.

According to the invention, it is also possible to provide a plurality of U-shaped lugs which are fastened in corresponding bracket-type seats. As a result, in order to obtain sufficiently reliable installation, the number of supporting points can be expanded virtually as desired when the individual insertion or hanging-in directions are harmonized with one another. Even in the event of a relatively large number of securing points, the play which is available in the securing according to the invention permits installation of a windshield wiper system with a relatively low outlay on adjustment and positioning if the number of securing elements to be precisely positioned is not increased at the same time. In particular heavy assemblies can thus be reliably secured by means of a plurality of closely adjacent U-shaped lugs, which are secured in bracket-type seats, without there being any concern about overloading in the body region.

1. A windshield wiper system for vehicles, comprising at least one assembly (4), which is composed of a wiper motor and gear, and at least three securing elements (5, 5′, 10) which are secured to securing points arranged in a triangle, wherein at least one securing element comprises a U-shaped lug (10) which is inserted or hung into a bracket-type seat (13) on a supporting structure.

2. The windshield wiper system as claimed in claim 1, characterized in that at least one U-shaped lug (10) is connected fixedly to a gear housing or gear cover of the assembly (4) composed of wiper motor and gear.

3. The windshield wiper system as claimed in claim 1, characterized in that at least one U-shaped lug (10) is arranged on the outer side of the wiper motor.

4. The windshield wiper system as claimed in claim 1, characterized in that the U-shaped lug (10) comprises a rectilinear transverse web (11) having a round cross section.

5. The windshield wiper system as claimed in claim 1, characterized in that the U-shaped lug (10) comprises a rectilinear transverse web (11) having a cross section which extends in one direction.

6. The windshield wiper system as claimed in claim 1, characterized in that a damping element (15) is arranged between the U-shaped lug (10) and the bracket-type seat (13).

7. The windshield wiper system as claimed in claim 1, characterized in that further securing elements include corresponding pairs of securing elements which are brought into engagement with one another in a direction deviating from the direction of insertion of the U-shaped lug (10) into the bracket-type seat (13), and are secured to one another.

8. The windshield wiper system as claimed in claim 1, characterized in that further securing elements include plug-in pins (5, 5′) which are introduced into corresponding openings in a direction deviating from the direction of insertion of the U-shaped lug (10) into the bracket-type seat (13) and are fixed in said openings.

9. The windshield wiper system as claimed in claim 1, characterized in that, in order to obtain the retaining action on non lug-shaped securing elements, damping elements which act in a frictional and interlocking manner are provided at the respective securing points.

10. The windshield wiper system as claimed in claim 1, characterized in that the bracket-type seat (13) on the supporting structure is a sheet-metal bracket which protrudes out of the body plane (14).

11. The windshield wiper system as claimed in claim 2, characterized in that at least one U-shaped lug (10) is arranged on the outer side of the wiper motor.

12. The windshield wiper system as claimed in claim 11, characterized in that the U-shaped lug (10) comprises a rectilinear transverse web (11) having a round cross section.

13. The windshield wiper system as claimed in claim 11, characterized in that the U-shaped lug (10) comprises a rectilinear transverse web (11) having a cross section which extends in one direction.

14. The windshield wiper system as claimed in claim 11, characterized in that a damping element (15) is arranged between the U-shaped lug (10) and the bracket-type seat (13).

15. The windshield wiper system as claimed in claim 14, characterized in that further securing elements include corresponding pairs of securing elements which are brought into engagement with one another in a direction deviating from the direction of insertion of the U-shaped lug (10) into the bracket-type seat (13), and are secured to one another.

16. The windshield wiper system as claimed in claim 15, characterized in that further securing elements include plug-in pins (5, 5′) which are introduced into corresponding openings in a direction deviating from the direction of insertion of the U-shaped lug (10) into the bracket-type seat (13) and are fixed in said openings.

17. The windshield wiper system as claimed in claim 16, characterized in that, in order to obtain the retaining action on non lug-shaped securing elements, damping elements which act in a frictional and interlocking manner are provided at the respective securing points.

18. The windshield wiper system as claimed in claim 17, characterized in that the bracket-type seat (13) on the supporting structure is a sheet-metal bracket which protrudes out of the body plane (14).
